(19) United States
(12) Patent Application Publication
(10) Pub. No.: US 2003/0225840 A1
(43) Pub. Date: Dec. 4, 2003

(54) Change notification and update service for object sharing via publication and subscription

(76) Inventors: David H.J. Glassco, Surrey (CA); Martin M. Lacey, Surrey (CA)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/278,397

(22) Filed: Oct. 22, 2002

Related U.S. Application Data
(60) Provisional application No. 60/383,939, filed on May 28, 2002.

(51) Int. Cl. G06F 15/16

(52) U.S. Cl. 709/206

(57) ABSTRACT

An application service environment is equipped to facilitate object/data sharing between users of different organizations through publication and subscription. The facilitation includes facilitating a publication subscriber user in identifying subscribed publication object instances of interest. The facilitation further includes monitoring for changes to publication object instances, creating and delivering change notifications to the publication subscriber users accordingly. In one embodiment, the publication object instance change notification service is implemented as a web service, with server side methods and client side logic to effectuate the desired selective notification for the multiplicity of users of the different organizations.

### RELATED APPLICATION

This is a non-provisional application of provisional application No. 60/383,939, filed May 28, 2002, entitled, “Real Time Notification Service”. This application claims priority to said provisional application. The U.S. version of this application also incorporates the specification of said provisional application by reference.

### BACKGROUND OF THE INVENTION

1. Field of the Invention

The present invention relates to the field of electronic data/information processing. More specifically, the present invention relates to methods and apparatuses for providing application services, including object sharing publication and subscription services that include object instance change notification and update.

2. Background Information

Typically, user access to applications and data are controlled through user logons and user profiles administered by system administrators. Users are required to logon to individual application and/or file servers. Once logged on to an application/file server, a user's access authority to applications and/or data on the server is governed by the user's profile created and maintained by a system administrator. For example, if a system administrator has classified the user as a privileged user, as opposed to an unprivileged user, the control software of the server (e.g. the file subsystem, or the operating system itself) allows the user certain creation or deletion authority otherwise not available to other users classified as unprivileged users. On file servers, individual users may exercise further control or protection by e.g. password protecting or encrypting their own data, and controlling effective access and/or usage of these further protected data by controlling the distribution and sharing of the passwords and/or decryption keys.

With the advance of telecommunication and networking technology, and the availability of public data networks, such as the Internet, increasingly users are “interconnected” together, and applications as well as data need to be shared in a controlled manner among a very large set of user population with very different access needs. These earlier described log-on and system administrator administered user profile based prior art approaches are no longer able to provide the control with the desired flexibility and ease of administration. The problem is further compounded with function rich applications or hosted applications (commonly known as application services), such as the financial applications or application services available from FinancialCAD of Surrey, Canada, assignee of the present application, where user accesses and licensing are flexibly administered at a function offering or service level.

In co-pending U.S. patent application Ser. Nos. 09/771,514 and 09/771,515, entitled “METHOD AND APPARATUS FOR MANAGING AND ADMINISTERING LICENSING OF MULTI-FUNCTION OFFERING APPLICATIONS” and “METHOD AND APPARATUS FOR MANAGING PUBLICATION AND SHARING DATA” respectively, new approaches to managing and administering licensing of application services to organizations and their users, as well as managing and administering contribution to and usage of shared object/data are disclosed. In the disclosed new approaches, organizations within an application service delivery environment are characterized based on at least three organization types, service operator organizations, service provider organizations, and service consumer organizations. Service operator organizations may selectively form and license service packages and/or components, as well as object/data publications of their users to service provider organizations and service consumer organizations. In like manner, service provider organizations may selectively license service packages and/or components as well as object/data publications of their users to other service provider organizations and service consumer organizations.

In view of the multiplicity of organization types, organizations, users, user types, and object/data publications, an improved approach to keeping publication subscriber users appraised of and/or updated with changed underlying object/data instances of the publications is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIG. 2 illustrates a component view of an application service of the application service environment of FIG. 1, in accordance with one embodiment;

FIGS. 3a-3c illustrate the relationships between the various entities of the application service environment of FIG. 1, including the relationships between the different types of organizations, the account creation and administration method, and object/data sharing through publications and subscriptions, in accordance with one embodiment;

FIGS. 4a-4c illustrate properties and methods of a component object, data organization, and security of the application service environment of FIG. 1, in accordance with one embodiment;

FIG. 5 illustrates a method view of the present invention, in accordance with one embodiment;

FIGS. 6a-6c illustrate various approaches to organizing the relevant data associated with an object instance notification request, an object instance change event, and an object instance change notification, in accordance with one embodiment;

FIG. 7 illustrates the relevant operational flow of the data service of FIG. 2, in accordance with one embodiment;

FIGS. 8a-8d illustrate the relevant operational flows of the publication object instance change notification service of FIG. 2 (server side), in accordance with one embodiment;

FIG. 9 illustrates the relevant operational flows of the publication object instance change notification service (client side), in accordance with one embodiment;

FIG. 10 illustrates an overview of the execution method of the present invention, in accordance with one embodiment;

FIG. 11 illustrates the relevant operational flow of the runtime controller of FIG. 10, in accordance with one embodiment;

FIG. 12 illustrates a network environment suitable for practicing the present invention, in accordance with one embodiment; and

FIG. 13 illustrates an example computer system suitable for use as one of the administrator/user computer of FIG. 12 to practice the present invention, in accordance with one embodiment.

### DETAILED DESCRIPTION OF THE INVENTION

The present invention includes object instance change notification and update in an application service environment with publication and subscription support for object and/or data sharing among users of different organizations.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as objects, publications, subscribers, notifications, and so forth, commonly employed by those skilled in the art to convey the substance of their work to others skilled in the art. Parts of the description will be presented in terms of operations performed by a computer system, using terms such as requesting, processing, connecting, sending, retrieving, and so forth. As well understood by those skilled in the art, these quantities and operations take the form of electrical, magnetic, or optical signals capable of being stored, transferred, combined, and otherwise manipulated through mechanical and electrical components of a digital system; and the term digital system include general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may. The terms “comprising”, “having”, “including” and the like are synonymous.

### Overview

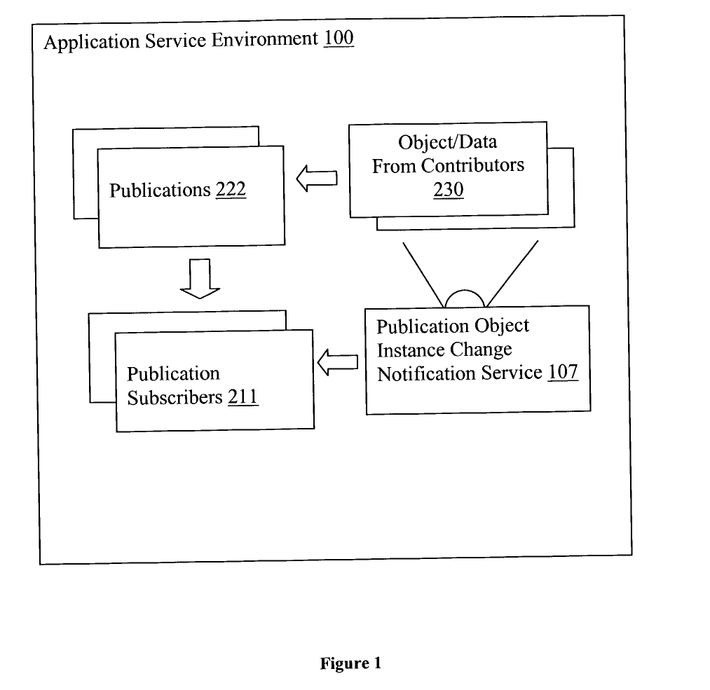

Referring now to FIG. 1, wherein an overview of the present invention in accordance with one embodiment is shown. As illustrated, within application service environment 100, different users of different organizations may contribute object and/or data 230 for sharing with other users of the same or different organizations. Users contributing objects and/or data 230 for sharing are referred to as object/data contributors. In various embodiments, an organization may be a service operator organization, a service provider organization, and a service consuming organization, to be described more fully below.

Further, contributed objects/data 230 (hereinafter, simply “objects”) are organized into publications 222 and offered for subscription by various authorized users of authorized organizations. Authorized users 211 may gain access to selected ones of contributed objects 230 by subscribing to corresponding ones of the offered publications 222.

In accordance with the present invention, to facilitate the various publication subscriber users 211 of the different organizations of application service environment 100 to be appraised of, and updated with changed instances of object 230 of publications 222, publication object instance change notification service 107 is provided.

As will be described in more detail below, publication object instance change notification service 107 facilitates publication subscriber users 211 in identifying the instances of objects 230 of publications 222 that are of interest. Further, publication object instance change notification service 107 monitors instances of objects 230 for changes. More specifically, in one embodiment, it monitors for reporting of change events.

Publication object instance change notification service 107 then notifies, as well as facilitates publication subscriber users 211 in obtaining copies of the changed instances of objects 230 of publications 222, based at least in part on the object instances of interest identified, and changes observed.

### Application Service Environment

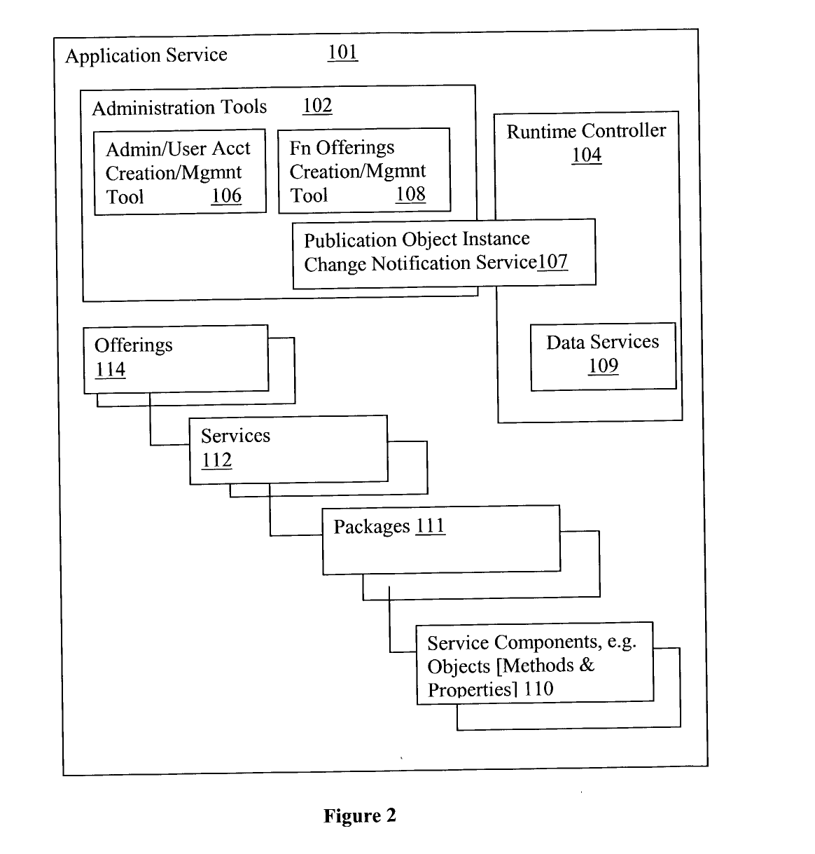

FIG. 2 illustrates the application service of environment 100 in further detail, in accordance with one embodiment. As illustrated, application service 101 (hereinafter, including the claims, simply application) includes a number of service components 110 (or simply components), and is provided with a number of administration tools 102 and runtime controller 104 to facilitate administration and management of user access and usage of components 110.

In one embodiment, application 101 is hosted on one or more servers, and the users are remote client users accessing components 110 remotely through networking connections, e.g. the Internet.

For the illustrated embodiment, as will be described in more details below, components 110 are selectively packaged into packages 111, which in turn are packaged into services 112, and then function offerings 114 for administration and management, i.e. licensing and access/usage control. However, in alternate embodiments, application service 101 may alternatively include more or less levels of organization/packaging of components 110.

For the purpose of this application, components are programmatic software entities commonly referred to as “objects”, having methods and properties, as these terms are well known in the context of object oriented programming. Packages are groupings of interdependent components similar in functional scope. Services are logical groupings of service functionality that when combined with other services provide broader information processing support. Functional offerings are sets of services offered and licensed to licensees. In alternate embodiments, other manners of grouping modules, functions and services may be practiced instead.

Administration tools 102 include in particular account creation/management (ACM) tool 106 and function offering/service creation/management (FCM) tool 108, whereas runtime controller 104 includes data services 109. For the embodiment, portions of publication object instance change notification (POICN) service 107 are part of administration tools 102, whereas other portions are part of runtime controller 104.

ACM tool 106 is equipped to facilitate creation of various administrator and end user accounts for various administrators and end users, including facilitation of empowerment of various administrators to administer control on user access to application 101, more specifically, functional offerings 114 and services 112. In one embodiment, the administrator and user accounts are organized by organizations. As described earlier, at least organizations of three types, service operator, service provider and service consumer, are recognized. In one embodiment, ACM tool 106 is also equipped to facilitate the logical creation of these organizations on the system hosting application 101.

FCM tool 108 is equipped to facilitate creation of the various function offerings 114 and services 112, including empowering of the various administrators of the various organizations in administering control on user access to components 110, through invocation of function offerings 114 and/or services 112.

In various embodiments, both ACM tool 106 and FCM tool 108 are also equipped to cooperate to facilitate data sharing through publication and subscription. For these embodiments, at least a portion of POICN service 107 is equipped to facilitate publication subscribers in requesting to be notified of changes to object instances of publications of interest.

Runtime controller 104 provides various runtime services to facilitate functions or components executions within application service environment 100. In various embodiments, runtime controller 104 includes in particular a data service 109 equipped to facilitate storing of object/data into persistent stores. In some of these embodiments, at least a portion of POICN service 107 is also equipped to monitor for changes to object instances of publications, and to facilitate the requested publication subscribers to be notified of the changes, as well as obtaining copies of the changed object instances of the publications of interest.

In various embodiments, POICN service 107 is implemented as a web service. In particular, the runtime portion of POICN service 107 includes server side methods and a client (executed on the client device of a publication subscriber user). The server side methods include connect and disconnect methods to facilitate publication subscriber users to connect and disconnect from the service, pause and resume methods to facilitate publication subscriber users to pause and resume change notification delivery, and a retrieve method for publication subscriber users in retrieving the changed object instances of interest. The client side cooperates with the server side through these methods to effectuate the desired object instance change notification and update for a publication subscriber user.

Before proceeding with additional description, it should be noted that application 101 is intended to represent a broad range of application known in the art, including in particular financial applications such as those offered by the assignee of the present invention. Further, while for ease of understanding, the present invention is presented in the context of application 101, from the description to follow, those skilled in the art would appreciate that the present invention may be practiced for other system/subsystem software products or services, as well as other multi-media contents, including but not limited to video, audio and graphics. Accordingly, unless specifically limited, the term “application” as used herein in this patent application, including the specification and the claims, is intended to include system and subsystem software products and services, as well as multi-media contents.

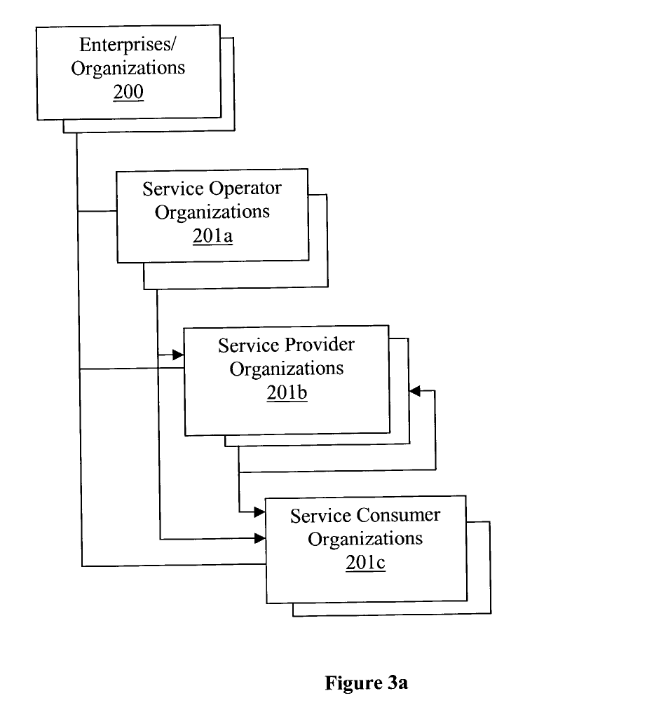

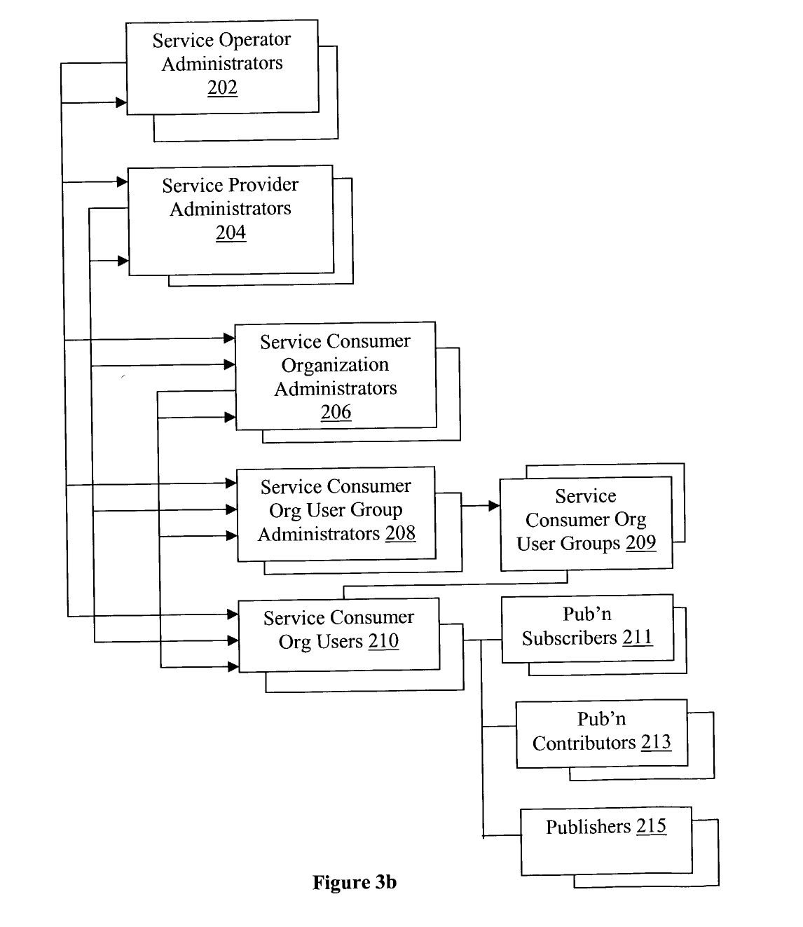

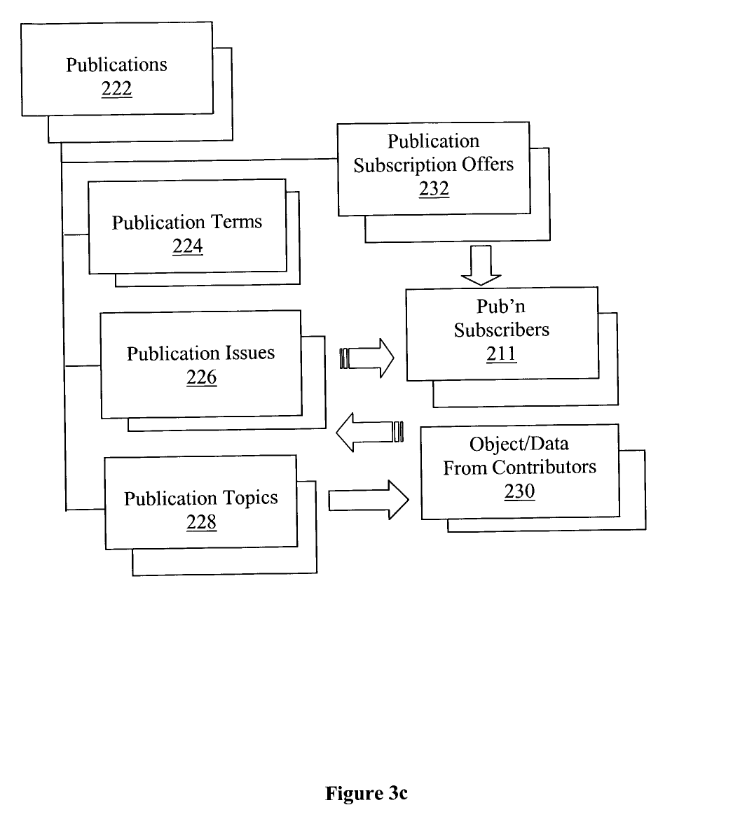

Referring now to FIGS. 3a-3c, wherein an overview of the relationship between the various entities of application service environment 100, including the relationships between the various organizational types, the administrator and user account creation and management method, and data sharing through publication and subscription, in accordance with one embodiment, is shown.

As illustrated in FIG. 3a and alluded to earlier, for the embodiment, organizations 200 may be classified into one of at least three types, service operator, service provider, and service consumer. For the purpose of this application, a service operator organization 201a is an organization that operates the hardware, i.e. one or more servers, hosting application or application services (101 of FIG. 2) of environment 100, and licenses all or selected combinations of the functions and services of application to service provider organizations 201b, which in turn may license the licensed functions or services, or selected subsets, to one or more other service provider and/or consumer organizations 201b and 201c. A service consumer organization 201c is an organization of users licensed by a service provider organization 201b to use all or a subset of the functions and/or services of application provided by the service provider organization 201b. For the embodiment, a service operator organization 201a may also act in the role of a service provider organization 201b, i.e. licensing all or a subset of the functions/services of application to one or more service consumer organizations 201c directly.

As illustrated in FIG. 3b, for the embodiment, an administrator 202 of a service operator organization creates administrator accounts for administrators of service provider organizations 204. An empowered administrator 202 of a service operator organization may also create administrator accounts for other administrators of the service operator organization. Administrators 202 of the service operator organization also empower administrators 204 of the organization's service provider organizations to further create other administrator and user accounts, and administer control on user access to components 110 of application 101 (through access to functional offerings 114 or services 112).

Continuing to refer to FIG. 3b, an empowered administrator 204 of a service provider organization in turn would create administrator accounts for administrators 206 of service consumer organizations of the service provider organization. Similarly, an empowered administrator 204 of a service provider organization may also create other administrator accounts for other administrators of the service provider organization. An empowered administrator 204 of a service provider organization also empowers administrators 206 of the organization's service consumer organizations to create user accounts for users 210 of the organization's service consumer organizations, and administer control on user access to components 110 of application 101 (through access to functional offerings 114 or services 112) within the respective licensee organizations.

For the illustrated embodiments, service consumer organizations are constituting organization units of licensee enterprises of application 101. Each service consuming licensee enterprise may have one or more physical organization units. Each organization unit may be a wholly owned subsidiary, a division, a group, or a department. In other words, it may be any one of a number of business organizational entities.

Moreover, an empowered administrator 206 of a service consumer organization may also create one or more user groups 209, associates users 210 as members of user groups 209, as well as creating group administrator accounts for user group administrators 208 of the service consumer organization. Similarly, in alternate embodiments, the present invention may also be practiced without the employment of user groups or with more levels of user organizations.

Note that an administrator is also a “user”, only a special “user”, having assumed the role or responsibility of administration. Similarly a service operator or a service provider is also an “enterprise”, only a special “enterprise”, having assumed the role or responsibilities described above for a service operator and a service provider respectively. Moreover, each service operator, as well as each service provider, may have its own “organization” administrators, user groups and users. However, for ease of understanding, the present invention will be described using these terms delineating the roles assumed by the different enterprises/users. Further, the present invention will only be described in terms of a service operator delegating and empowering a service provider, and an empowered service provider in turn delegating and empowering administrators of a service subscribing licensee service consumer organization, and so forth. Those skilled in the art would appreciate that the description applies equally to the service operator/provider's own organization administrator, user groups and end users.

In one embodiment, an empowered administrator 202 of a service operator organization is also able to create the administrator accounts and the end user accounts of a service consumer organization directly, skipping the creation and licensing of a service provider organization, or one or more of the administrators 204 of the organization's licensed service provider organizations, and in the case of user accounts, the administrators 206 of the service consumer organizations. Similarly, an empowered administrator 204 of a service provider organization is also able to create user group administrators 208, user groups 209, and end user accounts for users 210 of a service consumer organization directly, skipping administrators 206 of the organization's service consumer organization. In other words, for the illustrated embodiment, an administrator 202 of a service operator organization may perform all administration and management tasks an administrator 204 of a service provider organization of its creation, as well as an administrator 206 of a service consumer organization of the service provider organization may perform. An administrator 204 of a service provider organization may perform all administration and management tasks an administrator 206 of a service consumer organization of its creation may perform.

Thus, it can be seen from the above description, within application service environment 100, the administration and management of licensing, i.e. logical creation of the organizations, creations of the administrator/user accounts, control of user access to an application, are advantageously hierarchical and decentralized, with the administration responsibilities distributable/delegatable to administrators at various levels of the administration hierarchy. Experience has shown, the hierarchical decentralized or distributed approach is much more flexible, and particular suitable for administering and managing licensing of applications with complex multi-functions, to a large customer base with a large number of end users, across a large number of organizations, over wide area networks.

Still referring to FIG. 3b, as illustrated, to facilitate object sharing between users of the same and different organizations 210a-210c in a controlled manner, administrators 202-206 of the various organizations 201a-201c may also authorize selected users 210 subject to their administration, to be publishers 215 of object publications 222, object contributors 213 to object publications 222 (if permitted by the owner users 215 of the object publications 222), and/or object subscribers 211 to object publications 222 (also if permitted by the owner users 215 of the object publications 222).

As illustrated in FIG. 3c, an object publisher 215 may create and manage one or more object publications 222, thereby becoming the owner user of the object publications 222. An object publisher user 215 may specify the terms 224 of the object publications 222, such as, trial, weekly, bi-weekly, monthly, and so forth, resulting in the object publications 222 being available for different lengths of time under different commercial terms of subscription.

An object publisher user 215 may also specify and authorize one or more other users 210 to contribute their data to selected ones of the object publisher user's object publications 222 (provided the authorized contributor users 213 are also authorized by his/her administrators 202-206 to contribute their object to other users' object publications 222). In other words, within application service environment 100, an object publication 222 may contain data from the owner publisher user 215 as well as data from non-owner contributor users 213. Moreover, data contribution by non-owner contributor users 213 are subject to the control of the owner of the object publication 222 as well as the administrators 202206 with administration power over the potential non-owner contributor users 213 authorized by the owner publisher user 215.

An object publisher user 215 may also specify the publication topic 228 of an object publication 222, thereby controlling the nature of the data contributable to the object publication 222.

Further, an administrator of a service consumer organization 210c (or its licensor service operator/provider organization 201a/201b) may also create publication subscription offers 232 to offer object publications 222 for subscription by users of the organization 201c. Authorized users 210 in turn may subscribe to offered publications 232 of interest. That is, within application service environment 100, object subscriptions are subject to the control of the administrators 202-206, on who may subscribe to object publications 222 as well as what object publications 222 can be subscribed.

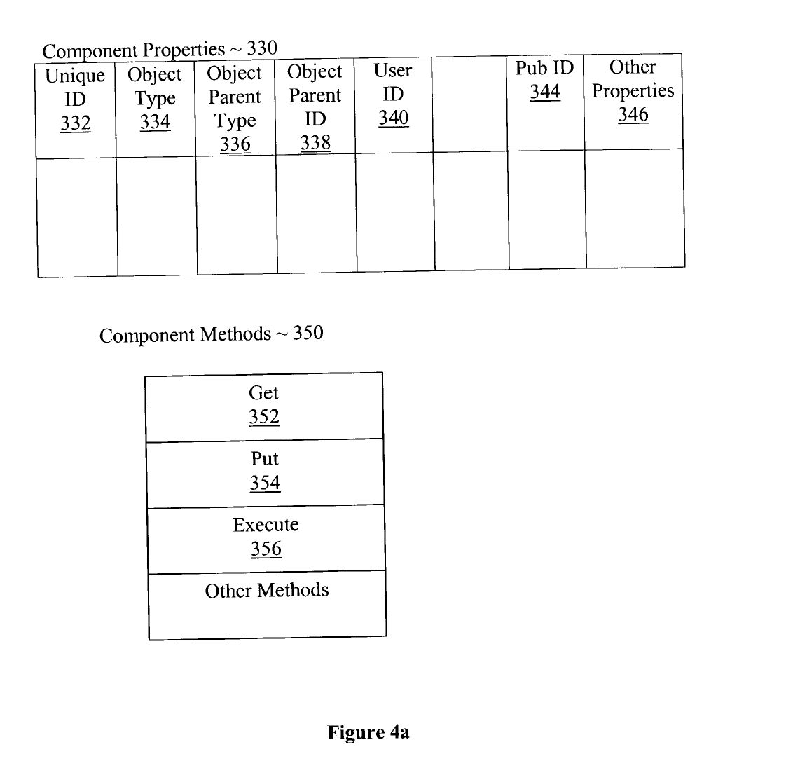

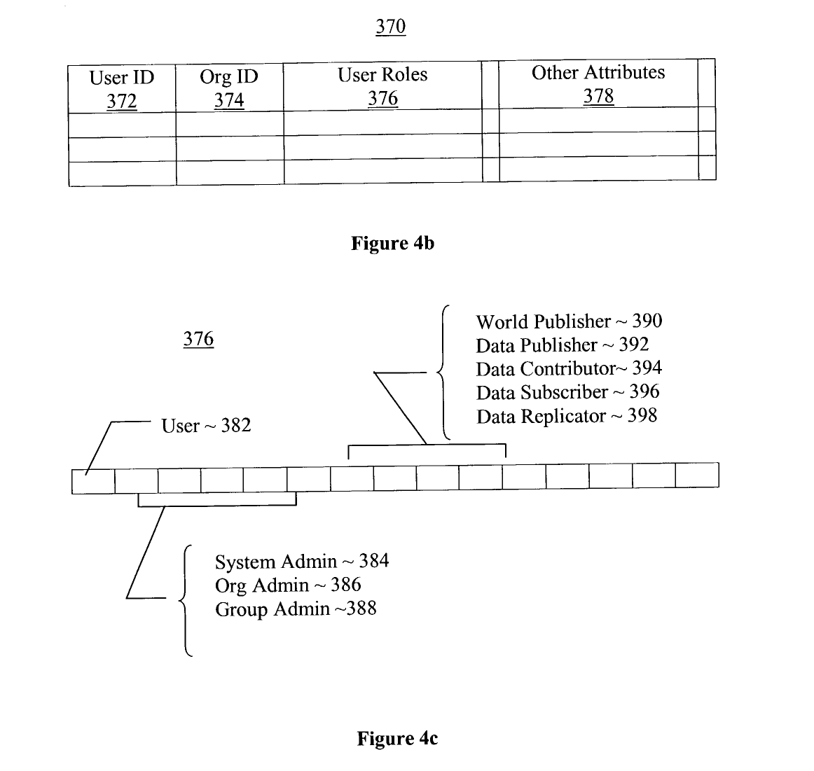

FIG. 4a illustrates in further detail the properties of a component 110, and its methods, in accordance with one embodiment. As illustrated in FIG. 4a, for the embodiment, each component 110 includes a unique identifier 332 identifying the component, and a type property 334 to identify the object type of the component. Further, each component 110 includes properties 338 and 336 describing the parent object's identifier and the object type of the parent object respectively. Additionally, each component 110 includes property 340 identifying the user owner, and if applicable, property 344 identifying the data publication with which the component is associated with. As illustrated, component 110 may also include other properties 346.

As alluded to earlier, each component 110 has a number of methods. For the illustrated embodiment, the methods 350 include at least a Get method 352 for retrieving data associated with the component and other applicable subscribed publishing components, a Put method 354 to store a copy of data present in the component into memory or mass storage, and an Execute method 356 to perform a pre-determined computation using the data of the component and other applicable subscribed publishing components. Of course, each component 110 may also include other methods.

FIGS. 4b-4c illustrate a security arrangement, in accordance with one embodiment. As illustrated in FIG. 4b, the organization identifier 374 of the organization to which a user is a member is tracked. For the embodiment, each organization is typed, as earlier described. Further, the organization types are tracked (not shown). Accordingly, based on the tracked organization identifier 374 of an organization, the organization type of the organization to which a user is a member may be determined.

Additionally, the various user roles 376 a user may operate in, as authorized by the administrators with administrative power over the user, are also tracked. In one implementation, as illustrated in FIG. 4c, all users are authorized to use the functions/services of application 101 authorized for its user group (which may be all or a subset of the functions/service of application 101 licensed to the user's organization) as a user. Additionally, each user may be optionally authorized to operate in a group administrator role 388 for its user group, an organizational administrator role 386 for its organization, and/or a system administrator role 384 (if the user is a member of a service operator or service provider organization). Further, each user may be optionally authorized to operate in a publisher role 392 publishing data publications, a contributor role 394 contributing data to data publications, and/or a subscriber role 396 subscribing to data publications.

In one implementation, for efficiency of administration, a user may also be optionally authorized to operate in a world publisher role 390, whose data publications may be subscribed by any user of any organization.

In one embodiment, the authorized user roles are tracked in a multi-value user role variable.

For the embodiment, security is enforced in accordance with these authorized user roles. That is, only users authorized to operate as group administrators may administer the corresponding user groups, only users authorized to operate as organization administrators may administer the corresponding organizations, only users authorized to operate as system administrators may administer the corresponding service operator/provider and their descendant organizations. Only users authorized to operate as publishers (or world publisher)) may publish data publications, only users authorized to operate as contributors may tag and contribute their data to data publications (as authorized by the owners of the data publications), and only users authorized to operate as subscribers may subscribe to offered data publications. Lastly, only users authorized to operate in the contract creator role may create a service offer or counteroffer, and only users authorized to operate in the contract acceptor role may accept a service offer or counteroffer.

### Method

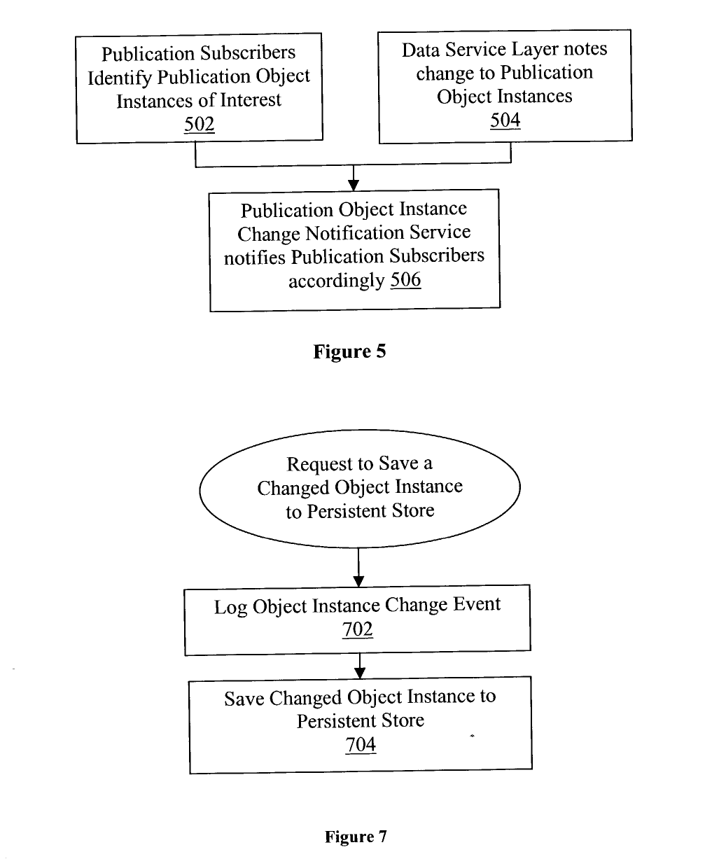

FIG. 5 illustrates a method view of the present invention, in accordance with one embodiment. As illustrated, for the embodiment, publication subcribers, using POICN service 107 (more specifically, the “tool” portion), identify for POICN service 107 publication object instances of interest, block 502. In one embodiment, publication subcriber users identify for POICN service 107 the publication object instances of interest by creating object instance change notification requests, using POICN service 107.

Further, POICN service 107 (more specifically, the “runtime” portion) monitors for changes to publication object instances, block 504. In one embodiment, data service 109 is equipped to record a change event for a publication object instance, whenever it stores the publication object instance into a persistent store. In one embodiment, data service 109 records the change events in a message queue. In ome embodiment, the message queue is a public message queue provided by the underlying operating system of application service environment 100. An example of a suitable underlying operating system is the Windows operating system available from Microsoft Corp., of Redmond, Wash.

For these embodiments, POICN service 107 monitors for the reporting of change events. In particular, for the message queue embodiments, POICN service 107 monitors for the recording of change events into the applicable message queue.

POICN service 107 then notifies publication subscribers of changes to object instances of publications that are of interest to the publication subscriber users, based at least in part on the change notification requests made by the various publication subscriber users of the various organizations, and changes to the publication object instances observed.

In various embodiments, POICN service 107 creates various notifications to be delivered to the applicable publication subscriber users accordingly. In various embodiments, the created notifications include the changed object instances themselves.

In various embodiments, POICN service 107 stores the various created notifications for delivery in various corresponding private message queues of the publication subscriber users. As will be described in more detail below, in various embodiments, the created notifications are held in the corresponding queues, and delivered when the publication subscriber users are connected to POICN service 107.

In other words, for these embodiments, the monitoring/logging of change events, the setting up of the notifications to be delivered, as well as the actual delivery of the notifications are all advantageously decoupled. Experience has shown that the advantageous decoupling of these processing provide for more efficient operation.

### Data Organizations

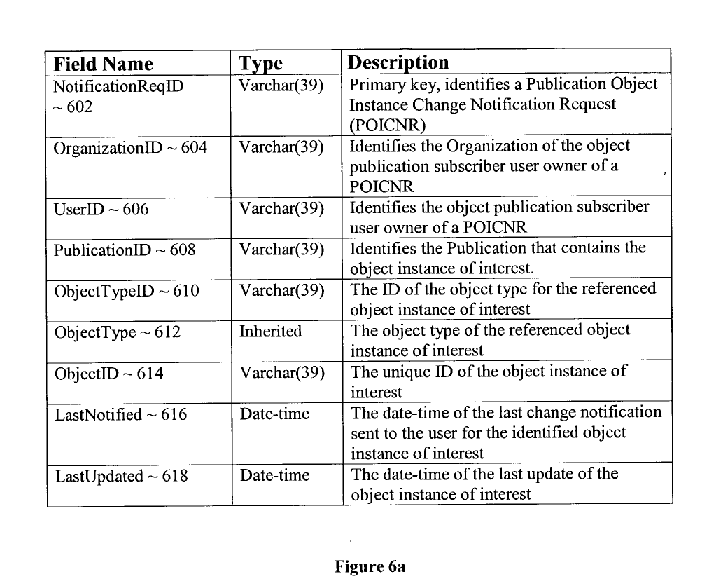

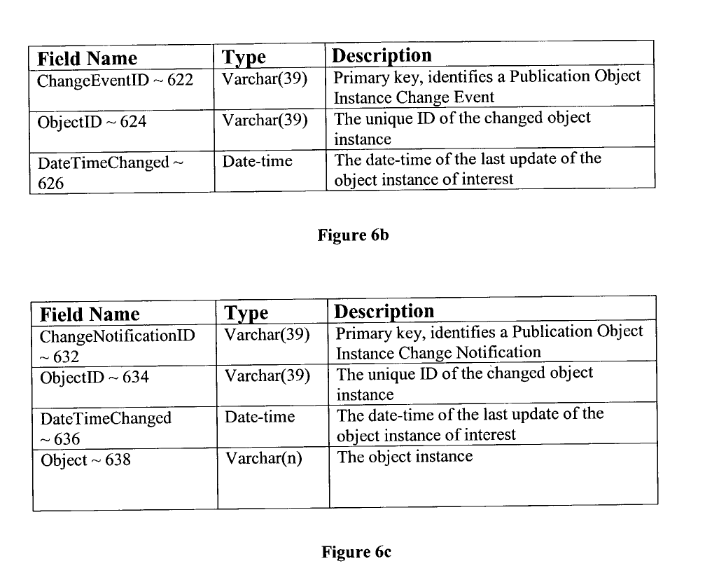

FIGS. 6a-6c illustrate various approaches to organizing the relevant data associated with an object instance notification request, an object instance change event, and an object instance change notification, in accordance with one embodiment.

As illustrated in FIG. 6a, for the embodiment, each object instance change notification request comprises a notification identifier 602 identifying the notification request, an organization identifier 604 identifying the organization of the publication subscriber user who made the request, and an user identifier 606 identifying the requesting publication subscriber user. For the embodiment, each publication object instance change notification request also includes a publication identifier 608 identifying the publication of interest, an object type identifier 610 and an object type 612 identifying the object type of the object instance of the publication of interest, and an object identifier 614 identifying the object instance of interest. For the embodiment, each publication object instance change notification request also includes a first and a second date-time 616-618 identifying the date-time the last change notification was provided to the requesting publication subscriber user, and the date-time the publication object instance of interest was last updated.

As illustrated in FIG. 6b, for the embodiment, each recorded object instance change event includes a change event identifier 622 identifying the change event, an object identifier 624 identifying the object instance which change is being recorded, and a date-time 626 identifying the date-time the object instance which change is being recorded.

As illustrated in FIG. 6c, for the embodiment, each object instance change notification includes a change notification identifier 632 identifying the change notification, an object identifier 634 identifying the object instance which change is being notified, and a date-time 636 identifying the date-time of the change of the object instance. For the embodiment, the change notification also includes the changed object instance itself 638.

### Data Service

FIG. 7 illustrates the relevant operational flow of the data service of the runtime controller of FIG. 2, in accordance with one embodiment. As described earlier, data service 109 of runtime controller 104 is equipped to store object instances into one or more persistent stores. More specifically, upon requested, data service 109, in addition to storing the request object instance into an appropriate persistent store, block 704, records a change event for the object instance, block 702.

As described earlier, in one embodiment, the change event is recorded in a message queue. More specifically, in one embodiment, the change event is recorded in a public message queue of the underlying operating system of application service environment 100.

### Publication Object Instance Change Notification Service (Server Side)

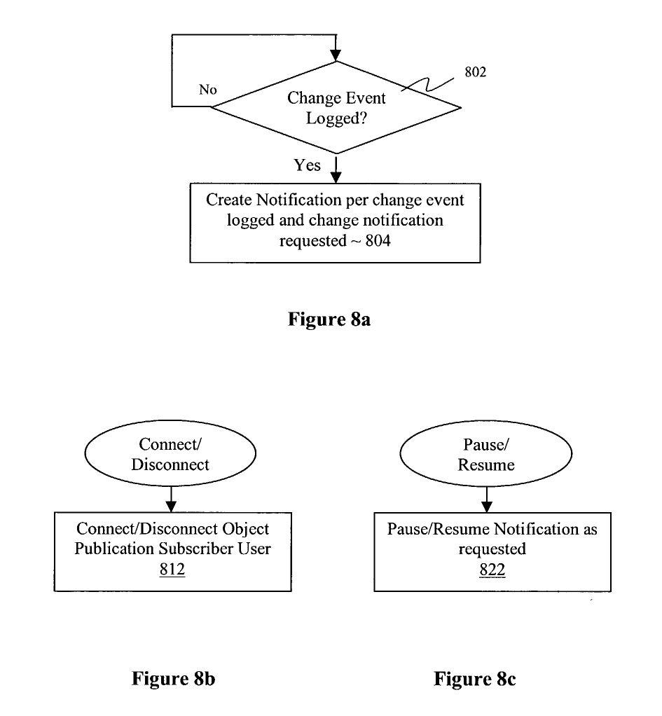

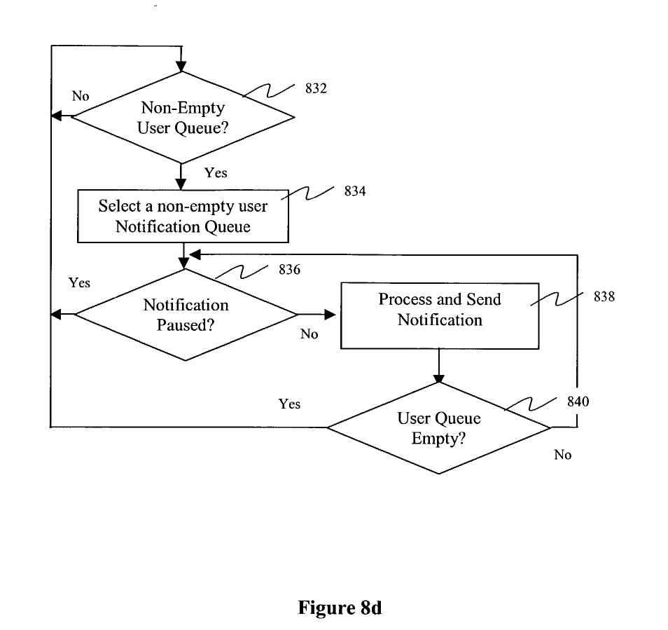

FIGS. 8a-8d illustrate the relevant operational flows of the publication object instance change notification service of FIG. 2 (server side), in accordance with one embodiment. More specifically, FIGS. 8a-8d illustrate the operational flows of POICN service 107 for processing the recorded change events, and processing the created notifications respectively. The embodiment assumes the earlier described web service embodiment. That is, the “runtime” portion of POICN service 107 includes connect and disconnect methods for connecting and disconnecting a publication subscriber user to service 107, and pause and resume methods for pausing and resuming delivery of change notifications. Additionally, for the embodiment, the “runtime” portion of POICN service 107 also includes (user) session processing logic.

The operational flow of POICN service 107 for facilitating a publication subscriber user in creating an object instance change notification request is within the ability of those ordinarily skilled in the art, accordingly will not be described.

Referring now to FIG. 8a, as illustrated, for the embodiment, POICN service 107 monitors the message queue which data service 109 records change events for publication object instances. POICN service 107 determines if the message queue is void of any recorded change event that requires processing, block 802. If no recorded change event requiring processing is detected in the message queue, no action is taken. The monitoring process continues.

However, if a recorded change event requiring processing is detected in the message queue, POICN service 107 de-queues the recorded change event, and creates one or more notifications for one or more publication subscriber users having requested change notifications of the changed object instance of the recorded change event, block 804. As described earlier, in various embodiments, the created notifications are stored in corresponding message queues of the publication subscriber users.

As illustrated in FIG. 8b, for the embodiment, upon receipt of a request to connect or disconnect a publication subscriber user, POICN service 107 connects or disconnects the publication subscriber user accordingly, block 812. In one embodiment, facilitating a publication subscriber user in connecting to POICN service 107 includes facilitating the publication subscriber user in registering a callback for POICN service 107 to notify the publication subscriber user of changes to publication object instances of interest.

As illustrated in FIG. 8c, for the embodiment, upon receipt of a request to temporarily pause or resume change notification delivery to a connected publication subscriber user, POICN service 107 notes the “paused” or “resumed” state of the publication subscriber user accordingly, block 822. The noted “paused” or “resumed” state affects the delivery of change notifications accordingly.

As illustrated in FIG. 8d, for the embodiment, the session processing logic of POICN service 107, continuously monitors the private message queues of the various publication subscriber users having made the change notification requests, for change notifications to be delivered, block 832.

Upon detection of at least one non-empty message queue with one or more change notifications to be delivered, POICN service 107 selects one of the publication subscriber user message queues for processing, block 834. POICN service 107 determines whether the corresponding publication subscriber user is connected, and delivery is not paused, block 836. If the publication subscriber user is either disconnected or connected but delivery is paused, POICN service 107 continues processing at block 832 as earlier described.

However, if the corresponding publication subscriber user is connected, and delivery is not paused, POICN service 107 delivers one of the pending notifications to the publication subscriber user, block 838. Thereafter, POICN service 107 determines if all pending notifications for the publication subscriber user have been delivered, block 840. If not, processing continues back at block 836, else at block 832.

In other words, for the embodiment, change notifications for a publication subscriber user is accumulated for the publication subscriber user when the publication subscriber user is disconnected. The accumulated change notifications are delivered to the publication subscriber user upon connection, unless the publication subscriber user pauses delivery immediately upon connection.

In one embodiment, the client side logic of the publication subscriber user announces the receipt of the change notification to interested party or parties of the publication subscriber user client. In one embodiment, the client side logic further invokes the retrieve method of POICN service 107 to retrieve the changed object instance. In one embodiment, the retrieved change object is returned as a string array.

### Publication Object Instance Change Notification Client

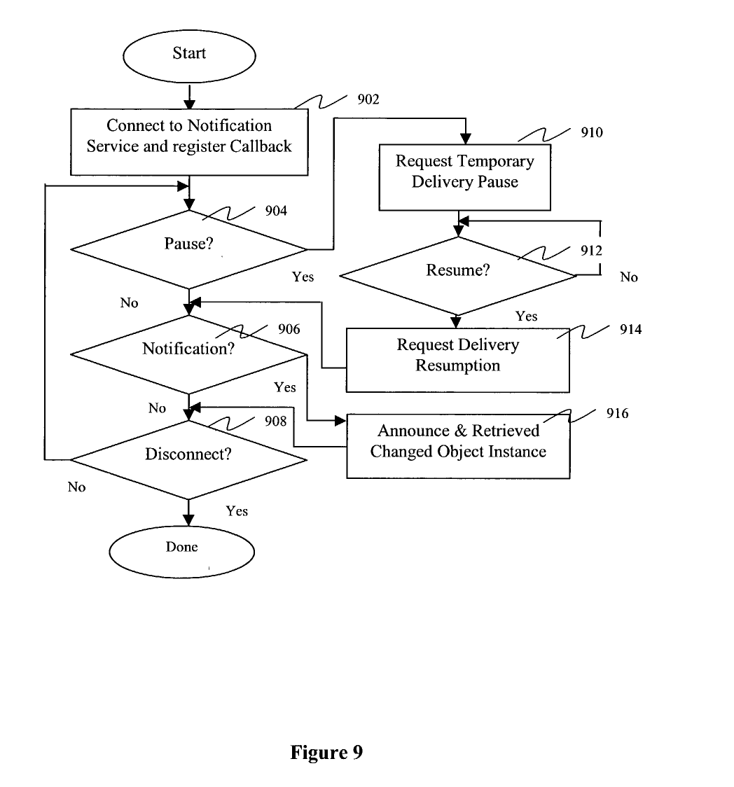

FIG. 9 illustrates the relevant operational flows of the publication object instance change notification client, in accordance with one embodiment. As illustrated, for the embodiment, upon start up/reset, the client of a publication subscriber user invokes the connect method of POICN service 107 to connect the client of the publication subscriber user to service 107. As described earlier, in one embodiment, the connection process includes registration with service 107 a callback for service 107 to notify the client of publication object instance changes, block 902.

Thereafter, the client waits for instructions from the user or notifications from service 107, blocks 904-908. If the user instructs the client to temporarily pause change notification delivery, the client invokes the pause method of POICN service 107 to pause change notification delivery accordingly, block 910.

Upon having caused a temporary pause in change notification delivery, POICN service 107 waits for the user's instruction to resume change notification delivery, block 912. Upon receipt from the user an instruction to resume change notification delivery, the client invokes the resume method of service 107 to resume change notification delivery accordingly, block 914.

Back at block 906, if the client is connected to service 107, delivery is not paused, and a change notification is received from service 107, for the embodiment, the client announces the change to other parties of interest, and invokes the retrieve method of service 107 to retrieve the changed object instance, block 916.

At block 908, if neither a notification is received from service 107 nor an instruction to disconnect is received from the user, the client continues operation at block 904. If an instruction to disconnect is received from the user, the client invokes the disconnect method of service 107 to disconnect the client from POICN service 107 accordingly.

In various embodiments, the communications between the client and server side of POICN service 107 are achieved through one or more known messaging protocols, such as SOAP (Simple Object Access Protocol).

### Runtime, Networking Environment, and Example Computer System

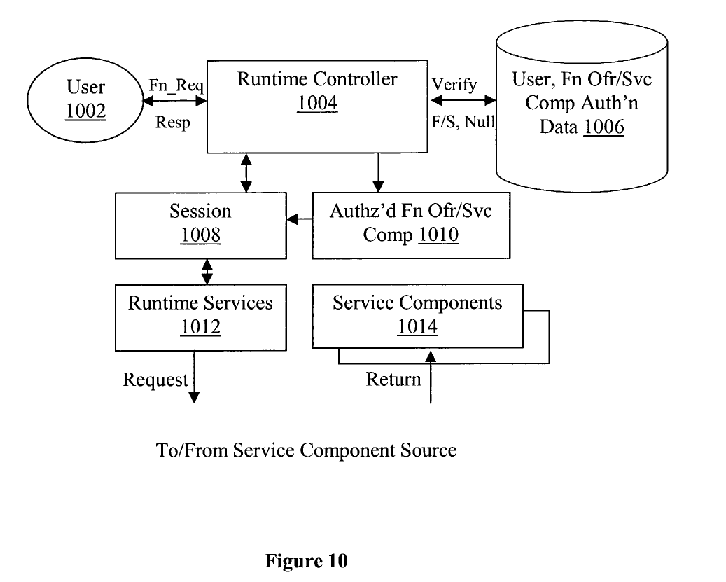

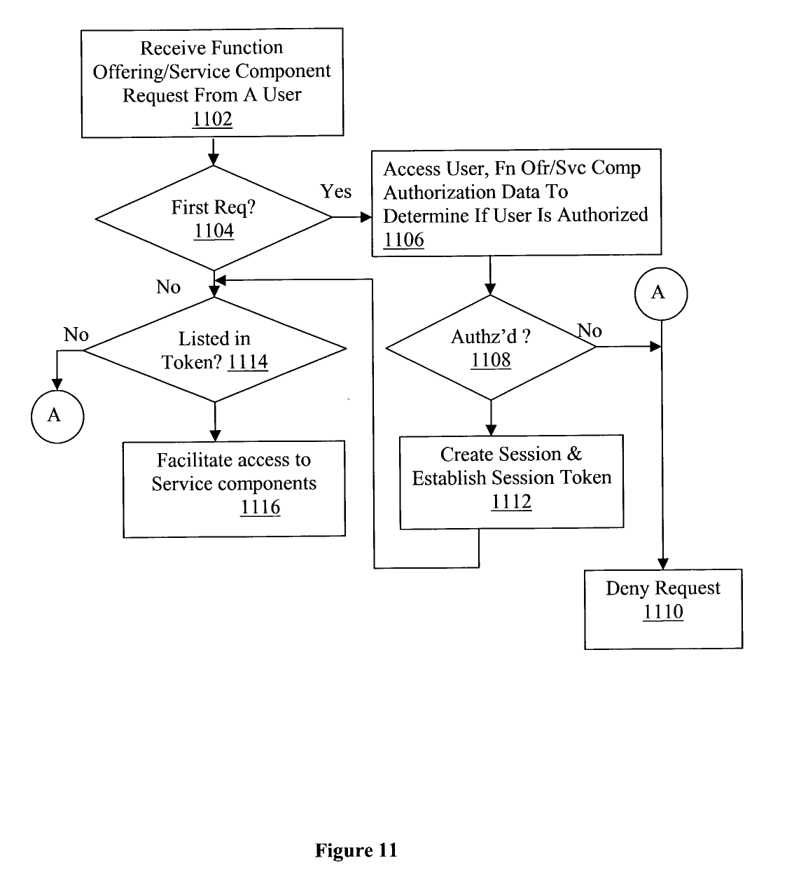

FIGS. 10 and 11 illustrate an overview of a function offering or service launching method of the present invention, in accordance with one embodiment. As illustrated, user 1002 submits a function request (Fn_Req) to runtime controller 1004 (same as runtime controller 104 of FIG. 1) (block 1102). In response, runtime controller 1004 determines if this is the first request from user 1002, i.e. whether a session environment has previously been created for requesting user 1002 (block 1104). If the request is the first request and the session environment is yet to be created, runtime controller 1004 accesses users and function offerings/services authorization database 1008 to verify user 1002 is “enabled”, i.e. authorized to access at least one service or function offering (blocks 1106 and 1108). In one embodiment, if user is “enabled”, runtime controller 1004 also accesses users and function offerings/services authorization data 1008 to determine if the user is an eligible shared data publisher, contributor, and/or subscriber, and if so, the applicable data publications, if any. Users and function offerings/services authorization data 1008 includes a data organization having user, function offering/service authorization and enabling information, and components 110 having multi-value user variable 376 as earlier described referencing FIG. 4c. Further, in an embodiment where data sharing through publication and subscription of data publications, as earlier described is supported, data 1008 further includes the applicable data publications published, contributed or subscribed by the user.

If user 1002 is not “enabled” (authorized) to access at least one service or function offering (nor any shared data), the request is rejected or denied (block 1110). If user 1002 is “enabled” (authorized) to access at least one service or function offering (or at least some shared data), runtime controller 1004 establishes a session environment 1008 for the user, instantiates various runtime services 1012 for the session 1008, retrieves a token 1010 listing all the authorized function offerings and services of the user, and associates token 1010 with session 1008 (block 1112). In an embodiment where data sharing through publication and subscription is supported, token 1010 further includes identification of the applicable data publications and/or replication items, if any. For the earlier described publication and subscription approach, applicable ones of the data publications are resolved through the properties of the data publications and related objects.

Upon doing so, or earlier determining that the request is not a first request, and such a session environment had been previously established for the user, runtime controller 1004 transfers the request to an appropriate runtime service to handle (e.g. the earlier described replicate request to a replicate service). Thereafter, runtime services 1012 retrieve and instantiate the appropriate service components or objects associated with the requested service or applicable services associated with the requested function offering 1014 in accordance with whether the requested services/function offerings are among the authorized ones listed in token 1010 created for the session 1008. Further, during execution, the user is conditionally given access to use the earlier described Get, Put, and Execute method associated with the “authorized” service components, depending on whether the user has been given the right to access these methods (blocks 1114-1116). Recall a non-user owner is implicitly given the right to use these methods, for being a member of an authorized user group of the user owner, or a fellow user of the authorized organization/enterprise of the user owner. Alternatively, the non-user owner may have been implicitly given the right to use these methods because the user has been authorized to operate in certain user roles.

Moreover, in an embodiment where data sharing through publication and subscription as earlier described is supported, an authorized user is given access to contribute or retrieve data of the applicable data publications. In the presently preferred embodiments, a contributor contributes data to a data publication by tagging the contributing data to the target data publication. Tagging of contributing data to the target data publications result in their association (and not actual copying of the contributing data into the data publication). The data content of a data publication is coalesced together when it is accessed or retrieved by a data subscriber.

Runtime services 1012 are intended to represent a broad range of runtime services, including but are not limited to memory allocation services, program loading and initialization services, certain database or data structure interfacing functions, and so forth. In alternate embodiments, security token 1010 may be statically pre-generated and/or dynamically updated to reflect dynamic changes in publications and subscriptions.

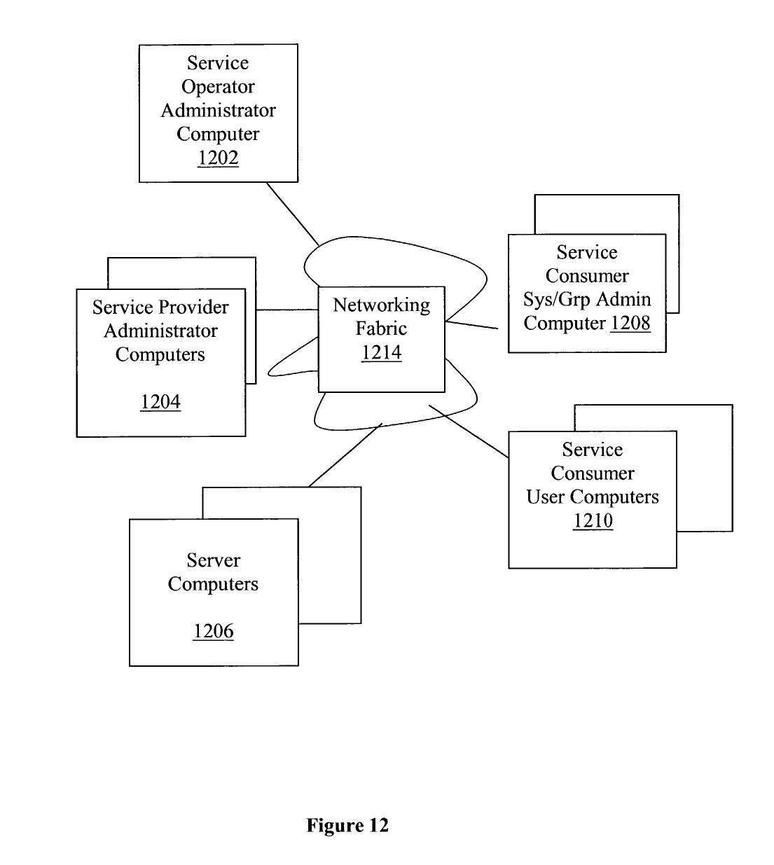

FIG. 12 illustrates a network environment suitable for practicing the present invention. As illustrated, network environment 1200 includes service operator administrator computer 1202, service provider administrator computers 1204, server computers 1206, organization administrator computers 1208, and end user computers 1210. The computers are coupled to each other through networking fabric 1214.

Server computers 1206 are equipped with the earlier described multi-function application 101 including administration tool 102 and runtime controller 104. In selected implementations, all or part of ACM 106 and FOM 108 are instantiated onto the respective computers 1202-1204 and 1208-1210 for execution. Similarly, for selected ones of function offerings 114, services 112, packages 111 or service components 110, all or part of these offerings, services, packages or service components are invoked by end user computers 1212 for execution.

In one embodiment, service operator administrator computer 1202, service provider administrator computers 1204 and server computer 1206 are affiliated with the vendor of application 101, while organization administrator computers 1208, and end user computers 1210 are affiliated with customers or service subscribers of application 101.

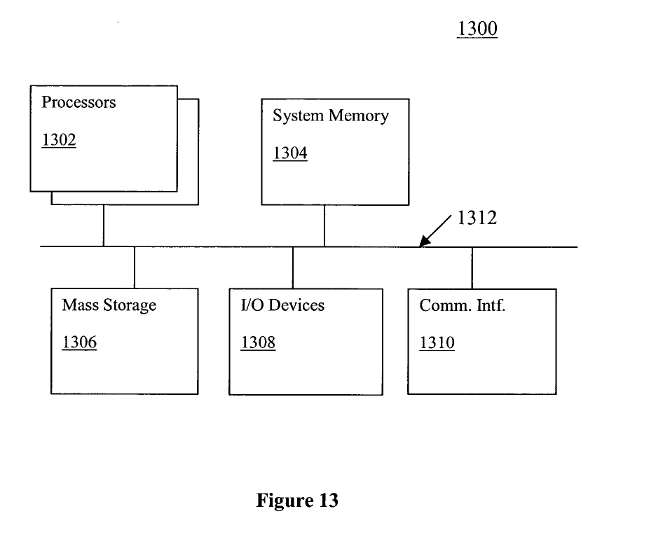

Computers 1202-1210 are intended to represent a broad range of computers known in the art, including general purpose as well as special purpose computers of all form factors, from palm sized, laptop, desk top to rack mounted. An example computer suitable for use is illustrated in FIG. 13. Networking fabric 1214 is intended to represent any combination of local and/or wide area networks, including the Internet, constituted with networking equipment, such as hubs, routers, switches as the like.

As alluded to earlier, FIG. 13 illustrates an example computer system suitable for use to practice the present invention. As illustrated, example computer system 1300 includes one or more processors 1302 (depending on whether computer system 1300 is used as server computer 1206 or other administrator/end user computers 1202-1204 and 1208-1210), and system memory 1304 coupled to each other via “bus” 1312. Coupled also to “bus” 1312 are non-volatile mass storage 1306, input/output (I/O) devices 1308 and communication interface 1314. During operation, memory 1304 includes working copies of programming instructions implementing teachings of the present invention.

Except for the teachings of the present invention incorporated, each of these elements is intended to represent a wide range of these devices known in the art, and perform its conventional functions. For example, processor 1302 may be a processor of the Pentium® family available from Intel Corporation of Santa Clara, Calif., or a processor of the PowerPC® family available from IBM of Armonk, N.Y. Processor 1302 performs its conventional function of executing programming instructions, including those implementing the teachings of the present invention. System memory 1304 may be SDRAM, DRAM and the like, from semiconductor manufacturers such as Micron Technology of Boise, Id. Bus 1312 may be a single bus or a multiple bus implementation. In other words, bus 1312 may include multiple buses of identical or different kinds properly bridged, such as Local Bus, VESA, ISA, EISA, PCI and the like.

Mass storage 1306 may be disk drives or CDROMs from manufacturers such as Seagate Technology of Santa Cruz of CA, and the like. Typically, mass storage 1306 includes the permanent copy of the applicable portions of the programming instructions implementing the various teachings of the present invention. The permanent copy may be installed in the factory, or in the field, through download or distribution medium. I/O devices 1308 may include monitors of any types from manufacturers such as Viewsonic of Walnut, Calif., and cursor control devices, such as a mouse, a track ball and the like, from manufacturers such as Logictech of Milpitas, Calif. Communication interface 1310 may be a modem interface, an ISDN adapter, a DSL interface, an Ethernet or Token ring network interface and the like, from manufacturers such as 3COM of San Jose, Calif.

Thus, a method and an apparatus for facilitating object/data sharing through publication and subscription including publication object instance change notification and update have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In a computing environment, a method of operation comprising:
facilitating a plurality of object publication subscriber users of a first plurality of organizations in making requests to be notified of changes to object instances of object publications to which the object publication subscriber users subscribe, the object publications being published by a plurality of object publication publisher users of a second plurality of organizations to facilitate sharing of the object instances with other users;
noting changes to object instances; and
notifying the plurality of object publication subscriber users of the first plurality of organizations of changes to object instances, based at least in part on notification requests made and changes to object instances noted.

2. The method of claim 1, wherein said facilitating of a plurality of object publication subscriber users of a first plurality of organizations in making requests to be notified of changes to object instances of object publications to which the object publication subscriber users subscribe comprises facilitating the plurality of publication subscriber users of the first plurality of organizations in creating notification request objects for object publications which object instances' changes the object publication subscriber users are to be notified, with each notification request object comprising a publication identifier and an object identifier identifying an object publication and an underlying object instance of the identified object publication the object publication subscriber user is interested in receiving change notification respectively.

3. The method of claim 2, wherein each notification request object further comprises a first date-time identifying a date-time the identified object instance was last modified, and a second date-time identifying a date-time a user notification was last sent.

4. The method of claim 3, wherein each notification request object further comprises a user identifier identifying the object publication subscriber user, and an organization identifier identifying an organization of the object publication subscriber user.

5. The method of claim 1, wherein
said noting of changes to object instances comprises a data service of the computing environment logging a change event for an object instance whenever the data service commits a new version of the object instance to a persistent store;
said notifying of the plurality of object publication subscriber users of the first plurality of organizations comprises processing of the change events logged and creating corresponding notifications for the object publication subscriber users.

6. The method of claim 5, wherein
said logging of a change event for an object instance comprises the data service logging a change event in a public message queue; and
said creating of corresponding notifications comprises processing the change events logged in the public message queue and creating the corresponding notifications in corresponding private queues of the object publication subscriber users.

7 The method of claim 5, wherein
said logging of a change event for an object instance comprises the data service logging an object instance identifier, and a date-time of change for the object instance; and
said creating of corresponding notifications comprises retrieving for each corresponding notification to be created, the changed object instance based on the logged object identifier, and including with each corresponding notification to be created, the date-time of change and the retrieved changed object instance.

8. The method of claim 7, wherein said retrieving of a changed object instance and inclusion of the retrieved changed object instance as part of the corresponding notification being created comprises formatting the retrieved changed object instance into an XML document.

9. The method of claim 1, wherein
the method further comprises facilitating connections and disconnects by the object publication subscriber users; and
said notifying of the plurality of object publication subscriber users of the first plurality of organizations comprises
transmitting notifications to the object publication subscriber users in real time as the notifications are created if the object publication subscriber users are connected;
accumulating the notifications if the object publication subscriber users are not connected; and
transmitting the accumulated notifications to the object publication subscriber users when the object publication subscriber users reconnect.

10. The method of claim 1, wherein
the method further comprises facilitating connections and disconnects as well as change notification pause and resumption by the object publication subscriber users; and
said notifying of the plurality of object publication subscriber users of the first plurality of organizations comprises
transmitting notifications to an object publication subscriber user in real time as the notifications are created if the object publication subscriber user is connected and change notification is not paused,
accumulating the notifications if the object publication subscriber user is not connected or connected but change notification is paused; and
transmitting the accumulated notifications to an object publication subscriber user when the object publication subscriber user reconnects or when change notifications are to be resumed.

11. The method of claim 1, wherein
said object instances are object instances of a web-based application service; and
said object publication subscriber users and said object publication publisher users are of different organizations of the web-based application service.

12. The method of claim 11, wherein said first and second organizations comprise one or more of service operator organizations, service provider organizations, and service consumer organizations of the web-based application service.

13. An apparatus comprising
storage medium having stored therein a plurality of programming instruction designed to enable the apparatus to
facilitate a plurality of object publication subscriber users of a first plurality of organizations in making requests to be notified of changes to object instances of object publications to which the object publication subscriber users subscribe, the object publications being published by a plurality of object publication publisher users of a second plurality of organizations to facilitate sharing of the object instances with other users,
note changes to object instances, and
notify the plurality of object publication subscriber users of the first plurality of organizations, based at least in part on the requests made and changes to object instances noted; and
at least one processor coupled to the storage medium to execute the programming instructions.

14. The apparatus of claim 13, wherein said programming instructions are designed to perform said facilitating of a plurality of object publication subscriber users of a first plurality of organizations in making requests to be notified of changes to object instances of object publications to which the object publication subscriber users subscribe by facilitating the plurality of publication subscriber users of the first plurality of organizations in creating notification request objects for object publications which object instances' changes the object publication subscriber users are to be notified, with each notification request object comprising a publication identifier and an object identifier identifying an object publication and an underlying object instance of the identified object publication the object publication subscriber user is interested in receiving change notification respectively.

15. The apparatus of claim 14, wherein each notification request object further comprises a first date-time identifying a date-time the identified object instance was last modified, and a second date-time identifying a date-time a user notification was last sent.

16. The apparatus of claim 15, wherein each notification request object further comprises a user identifier identifying the object publication subscriber user, and an organization identifier identifying an organization of the object publication subscriber user.

17. The apparatus of claim 13, wherein said programming instructions are designed to perform
said noting of changes to object instances by logging a change event for an object instance whenever a new version of the object instance is committed to a persistent store, and
said notifying of the plurality of object publication subscriber users of the first plurality of organizations by processing the change events logged and creating corresponding notifications for the object publication subscriber users.

18. The apparatus of claim 17, wherein said programming instructions are designed to perform
said logging of a change event for an object instance by the data service logging a change event in a public message queue, and
said creating of corresponding notifications by creating the corresponding notifications in corresponding private queues of the object publication subscriber users.

19 The apparatus of claim 17, wherein said programming instructions are designed to perform
said logging of a change event for an object instance by logging an object instance identifier, and a date-time of change for the object instance, and
said creating of corresponding notifications by retrieving for each corresponding notification to be created, the changed object instance based on the logged object identifier, and including with each corresponding notification to be created, the date-time of change and the retrieved changed object instance.

20. The apparatus of claim 19, wherein said programming instructions are designed to perform said retrieving of a changed object instance and inclusion of the retrieved changed object instance as part of the corresponding notification being created by formatting the retrieved changed object instance into an XML document.

21. The apparatus of claim 13, wherein
the programming instructions are further designed to facilitate connections and disconnects by the object publication subscriber users; and
the programming instructions are designed to perform said notifying of the plurality of object publication subscriber users of the first plurality of organizations by
transmitting notifications to the object publication subscriber users in real time as the notifications are created if the object publication subscriber users are connected;
accumulating the notifications if the object publication subscriber users are not connected; and
transmitting the accumulated notifications to the object publication subscriber users when the object publication subscriber users reconnect.

22. The apparatus of claim 13, wherein
the programming instructions are further designed to facilitate connections and disconnects as well as change notification pause and resumption by the object publication subscriber users; and
the programming instructions are designed to perform said notifying of the plurality of object publication subscriber users of the first plurality of organizations by
transmitting notifications to an object publication subscriber user in real time as the notifications are created if the object publication subscriber user is connected and change notification is not paused,
accumulating the notifications if the object publication subscriber user is not connected or connected but change notification is paused; and
transmitting the accumulated notifications to an object publication subscriber user when the object publication subscriber user reconnects or when change notifications are to be resumed.

23. The apparatus of claim 13, wherein said object instances are object instances of a web-based application service, and said object publication subscriber users and said object publication publisher users are of different organizations of the web-based application service.

24. The apparatus of claim 23, wherein said first and second organizations comprise one or more of service operator organizations, service provider organizations, and service consumer organizations of the web-based application service.

25. In a client device, a method of operation comprising:
connecting to a web based notification service, on behalf of an object publication subscriber user of a first organization;
registering a callback with the web based notificaiton service for the web based notification service to provide notifications for changes to one or more object instances of one or more subscribed object publications of interest to the object publication subscriber user of the first organization, the one or more subscribed object publications being object publications published by object publication publisher users of a second plurality of organizations to facilitate sharing of the object instnaces with other users; and
invoking a retrieve method of the web based notification service to retrieve the changed object instances of subscribed object publications of interest.

26. The method of claim 25, wherein the method further comprises identifying the subscribed object publications of interest to the web based notification service by creating subscribed object publication notification request objects, with each notification request object comprising a publication identifier and an object identifier identifying an object publication and an underlying object instance of the identified object publication the object publication subscriber user is interested in receiving change notification.

27. The method of claim 26, wherein each notification request object further comprises a first date-time identifying a date-time the identified object instance was last modified, and a second date-time identifying a date-time a user notification was last sent.

28. The method of claim 27, wherein each notification request object further comprises a user identifier identifying the object publication subscriber user, and an organization identifier identifying an organization of the object publication subscriber user.

29. The method of claim 25, wherein the method further comprises
invoking a pause method of the web based notification service to request the web based notification service to temporarily pause provision of requested change notifications, even though the client device remain connected; and
invoking subsequently a resume method of the web based notification service to request the web based notification service to resume provision of requested change notifications.

30. The method of claim 25, wherein said object instances are object instances of a web-based application service, and said object publication subscriber users and said object publication publisher users are of different organizations of the web-based application service.

31. The method of claim 30, wherein said first, and second plurality of organizations comprise one or more of service operator organizations, service provider organizations, and service consumer organizations of the web-based application service.

32. A client device, comprising:
storage medium having stored therein a plurality of programming instructions designed to
connect the client device to a web based notification service, on behalf of an object publication subscriber user of a first organization;
register a callback with the web based notificaiton service for the web based notification service to provide notifications for changes to one or more object instances of one or more subscribed object publications of interest to the object publication subscriber user of the first organization, the one or more subscribed object publications being object publications published by object publication publisher users of a second plurality of organizations to facilitate sharing of the object instances with other users, and
invoke a retrieve method of the web based notification service to retrieve the changed object instances of subscribed object publications of interest; and
a processor coupled to the storage medium to execute the programming instructions.

33. The client device of claim 32, wherein the programming instructions are further designed to identify the subscribed object publications of interest to the web based notification service by creating subscribed object publication notification request objects, with each notification request object comprising a publication identifier and an object identifier identifying an object publication and an underlying object instance of the identified object publication the object publication subscriber user is interested in receiving change notification.

34. The client device of claim 33, wherein each notification request object further comprises a first date-time identifying a date-time the identified object instance was last modified, and a second date-time identifying a date-time a user notification was last sent.

35. The client device of claim 34, wherein each notification request object further comprises a user identifier identifying the object publication subscriber user, and an organization identifier identifying an organization of the object publication subscriber user.

36. The client device of claim 32, wherein the programming instructions are further designed to enable the client device to
invoke a pause method of the web based notification service to request the web based notification service to temporarily pause provision of requested change notifications, even though the client device remain connected; and
to invoke subsequently a resume method of the web based notification service to request the web based notification service to resume provision of requested change notifications.

37. The client device of claim 32, wherein said object instances are object instances of a web-based application service, and said object publication subscriber users and said object publication publisher users are of different organizations of the web-based application service.

38. The client device of claim 37, wherein said first, and second plurality of organizations comprise one or more of service operator organizations, service provider organizations, and service consumer organizations of the web-based application service.
